(19) United States
(12) Patent Application Publication
(10) Pub. No.: US 2023/0404164 A1
(43) Pub. Date: Dec. 21, 2023

(54) AN AEROSOL-GENERATING SYSTEM COMPRISING AN ELECTROCHEMICAL SENSOR SWITCH

(71) Applicant: Philip Morris Products S.A., Neuchatel (CH)

(72) Inventors: Rui Nuno Rodrigues Alves BATISTA, Morges (CH); Ricardo CALI, Mannheim (DE); Alexandra SEREDA, Neuchatel (CH)

(73) Assignee: Philip Morris Products S.A., Neuchatel (CH)

(21) Appl. No.: 18/255,596

(22) PCT Filed: Dec. 8, 2021
(86) PCT No.: PCT/EP2021/084848

§ 371 Date: Jun. 2, 2023

(30) Foreign Application Priority Data
Dec. 11, 2020 (EP) 20213569.5

(51) Int. Cl. A24F 40/51; A24F 40/20; A24F 40/57; A24D 1/20; A24D 1/00; H05B 1/02

(52) U.S. Cl. CPC A24F 40/51; A24F 40/20; A24F 40/57; A24D 1/20; A24D 1/002; H05B 1/0244

(57) ABSTRACT

An aerosol-generating system is provided, including: an aerosol-generating article including an aerosol-forming substrate and an aerosol-forming marker; and an aerosol-generating device configured to receive the aerosol-generating article, the aerosol-generating device including: control electronics, an electrochemical sensor switch operably coupled to the control electronics, the electrochemical sensor switch being configured to change from a first state to a second state when the electrochemical sensor switch detects an amount of the aerosol-forming marker that is above or below a predetermined threshold amount, and a heater operably coupled to the control electronics via the electrochemical sensor switch, the control electronics being configured to cause the heater to deactivate when the electrochemical sensor switch changes from the first state to the second state, and the aerosol-generating article including a reservoir containing the aerosol-forming marker, the reservoir including a capsule including an outer shell formed from a thermally degradable material.

The present invention relates to an aerosol-generating system comprising an aerosol-generating device and an aerosol-generating article. The aerosol-generating device comprises an electrochemical sensor switch that can detect an aerosol-forming marker in the aerosol-generating article.

Aerosol-generating systems for delivering an aerosol to a user typically comprise an atomiser configured to generate an inhalable aerosol from an aerosol-forming substrate. Some known aerosol-generating systems comprise a thermal atomiser such as an electric heater or an inductive heating device. The thermal atomiser is configured to heat and vaporise the aerosol-forming substrate to generate an aerosol. Typical aerosol-forming substrates for use in aerosol-generating systems are nicotine formulations, which may be liquid nicotine formulations comprising an aerosol former such as glycerine and/or propylene glycol.

It would be desirable to provide an aerosol-generating system that can provide improved battery life and produce a consistent and satisfactory user experience.

There is provided an aerosol-generating system. The aerosol-generating system may comprise an aerosol-generating article. The aerosol-generating system may comprise an aerosol-forming substrate. The aerosol-generating system may comprise an aerosol-forming marker. The aerosol-generating system may comprise an aerosol-generating device. The aerosol-generating device may be configured to receive the aerosol-generating article. The aerosol-generating device may comprise control electronics. The aerosol-generating device may comprise an electrochemical sensor switch operably coupled to the control electronics. The electrochemical sensor switch may be configured to change from a first state to a second state when the electrochemical sensor switch detects an amount of the aerosol-forming marker that is above or below a predetermined threshold amount. The aerosol-generating device may comprise a heater. The heater may be operably coupled to the control electronics via the electrochemical sensor switch. The control electronics may be configured to cause the heater to deactivate when the electrochemical sensor switch changes from the first state to the second state.

There is also provided an aerosol-generating system comprising: an aerosol-generating article comprising an aerosol-forming substrate and an aerosol-forming marker; and an aerosol-generating device configured to receive the aerosol-generating article, the aerosol-generating device comprising: control electronics; an electrochemical sensor switch operably coupled to the control electronics, the electrochemical switch being configured to change from a first state to a second state when the electrochemical sensor switch detects an amount of the aerosol-forming marker that is above or below a predetermined threshold amount; and a heater operably coupled to the control electronics via the electrochemical sensor switch, the control electronics being configured to cause the heater to deactivate when the electrochemical sensor switch changes from the first state to the second state.

There is also provided a method of operating an aerosol-generating system comprising an aerosol-generating article and an aerosol-generating article. The method may comprise control electronics causing deactivation of a heater of the aerosol-generating device in response to an electrochemical sensor switch detecting that an amount of an aerosol-forming marker is above or below a predetermined threshold amount.

There is also provided a method of operating an aerosol-generating system comprising an aerosol-generating article and an aerosol-generating device, the method comprising: control electronics causing deactivation of a heater of the aerosol-generating device in response to an electrochemical sensor switch detecting that an amount of an aerosol-forming marker is above or below a predetermined threshold amount.

Deactivating the heater when the electrochemical sensor switch detects an amount of the aerosol-forming marker that is above or below a predetermined threshold amount may allow the aerosol-generating system to automatically stop heating the aerosol-generating article at the approximate time that the aerosol-forming substrate becomes depleted.

This may lead to improvements in energy management because the amount of energy wasted when an aerosol-generating device heats a depleted aerosol-generating article is reduced.

There may also be an improvement in the user experience because a user is not able to accidentally heat an aerosol-generating article with a depleted aerosol-forming substrate. Consequently, a user may be provided with a more consistent and satisfactory user experience.

As used herein, the term “aerosol-generating article” refers to an article for producing an aerosol. An aerosol-generating article typically comprises an aerosol-forming substrate that is suitable and intended to be heated or combusted in order to release volatile compounds that can form an aerosol. A conventional cigarette is lit when a user applies a flame to one end of the cigarette and draws air through the other end. The localised heat provided by the flame and the oxygen in the air drawn through the cigarette causes the end of the cigarette to ignite, and the resulting combustion generates an inhalable smoke. In contrast, in “heated aerosol-generating articles”, an aerosol is generated by heating an aerosol-forming substrate and not by combusting the aerosol-forming substrate. Known heated aerosol-generating articles include, for example, electrically heated aerosol-generating articles.

As used herein, the term “aerosol-forming substrate” refers to a substrate that is capable of producing upon heating volatile compounds, which can form an aerosol. The aerosol generated from aerosol-forming substrate may be visible to the human eye or invisible and may include vapours (for example, fine particles of substances, which are in a gaseous state, that are ordinarily liquid or solid at room temperature) as well as gases and liquid droplets of condensed vapours or aerosols.

As used herein, the term “aerosol-generating device” refers to a device comprising a heater or a heating element that interacts with the aerosol-forming substrate of the aerosol-generating article to generate an aerosol.

As used herein, the term “aerosol-forming marker” refers to one or more compounds or substances that are capable of producing upon heating volatile compounds, which can form an aerosol. An aerosol-forming marker differs from the aerosol-forming substrate in that the aerosol-forming marker is intended to be detected by an electrochemical sensor switch when the aerosol-forming marker is in its aerosolised form. Therefore, typically, an aerosol-forming marker is selected from compounds or substances that are not normally found in an aerosol-forming substrate. Examples of suitable aerosol-forming markers are discussed below.

In an example, the “amount” of the aerosol-forming marker is the concentration of the aerosol-forming marker. In such an example, the electrochemical sensor switch is configured to change from a first state to a second state when the electrochemical sensor switch detects a concentration of the aerosol-forming marker that is above or below a predetermined threshold amount.

The aerosol-generating article may comprise a reservoir containing the aerosol-forming marker.

The reservoir may be located within the aerosol-forming substrate.

The reservoir may be located at a position away from where the heater heats the aerosol-forming substrate. The reservoir may be located at a position adjacent where the heater heats the aerosol-forming substrate.

The aerosol-generating article may comprise a plurality of reservoirs, each of the plurality of reservoirs containing the aerosol-forming marker.

Each reservoir may have a volume that causes between 30 and 50 parts per million by volume of the aerosol-forming marker to be released.

Each reservoir may comprise a capsule. In one example, each capsule may comprise an outer shell. The outer shell may be formed from a thermally degradable material. In this way, the outer shell may thermally degrade material and release the aerosol-forming marker when the outer shell is heated to a particular temperature. The particular material forming the outer shell may be selected to correspond to a particular temperature at which the outer shell will degrade. In one example, the outer shell may be formed from a wax. The wax may be thermally reactive.

The material from which the outer shell is formed may be chosen based on the desired time period that the outer shell should withstand heating before it degrades to allow the aerosol-forming marker to escape. The thickness of the outer shell may be chosen based on the desired time period that the outer shell should withstand heating before it degrades to allow the aerosol-forming marker to escape. In this way, the configuration of the outer shell can be used to control the timing of the release of the aerosol-forming marker, and therefore provide some control over the timing of the deactivation of the heater.

In one example, each capsule may have a cylindrical shape. In another example, each capsule may have a spherical shape. In another example, each capsule may have a cube shape. In another example, each capsule may have a disc shape.

The aerosol-generating article may include a hollow cellulose acetate tube.

The aerosol-generating article may include a spacer element.

The aerosol-generating article may include a mouthpiece filter.

The aerosol-forming substrate, the hollow cellulose acetate tube, the spacer element and the mouthpiece filter may be arranged sequentially. The aerosol-forming substrate, the hollow cellulose acetate tube, the spacer element and the mouthpiece filter may be arranged in a coaxial alignment.

The aerosol-generating article may include a cigarette paper.

The aerosol-forming substrate, the hollow cellulose acetate tube, the spacer element and the mouthpiece filter may be assembled by a cigarette paper.

The aerosol-generating article may have a mouth-end and a distal end. In use, a user may insert the mouth-end into his or her mouth.

The aerosol-forming substrate may be provided in the form of a plug.

The aerosol-generating article may comprise a susceptor.

The susceptor may be a plurality of susceptor particles which may be deposited on or embedded within the aerosol-forming substrate. The susceptor particles may be immobilized by the aerosol-forming substrate and remain at an initial position. The susceptor particles may be homogeneously distributed in the aerosol- forming substrate. Due to the particulate nature of the susceptor, heat may be produced according to the distribution of the particles in the aerosol-forming substrate. Alternatively, the susceptor may be in the form of one or more sheets, strips, shreds or rods that may be placed next to or embedded in the aerosol-forming substrate. The aerosol-forming substrate may comprise one or more susceptor strips.

The aerosol-forming marker may be positioned within the aerosol-generating article. In one example, the aerosol-forming marker may be positioned at one location within the aerosol-generating article. In one example, the aerosol-forming marker may be positioned at multiple locations within the aerosol-generating article.

The aerosol-forming marker may be located within the aerosol-forming substrate.

The aerosol-forming marker may be located at a position away from where the heater heats the aerosol-forming substrate. The aerosol-forming marker may be located at a position adjacent where the heater heats the aerosol-forming substrate.

The aerosol-forming marker may be located at a radially outer portion of the aerosol-forming substrate.

Locating the aerosol-forming marker at a radially outer portion of the aerosol-forming substrate may allow the aerosol-forming marker to aerosolise relatively slowly when a heating blade type heater is used heat the aerosol-forming substrate. This arrangement may be advantageous in an example in which the control electronics causes deactivation of the heater when the amount of aerosol-forming marker detected by the electrochemical sensor switch exceeds a predetermined threshold amount.

Locating the aerosol-forming marker at a radially outer portion of the aerosol-forming substrate may allow the aerosol-forming marker to aerosolise relatively quickly when a heater that externally heats the aerosol-forming substrate is used. This arrangement may be advantageous in an example in which the control electronics causes deactivation of the heater when the amount of aerosol-forming marker detected by the electrochemical sensor switch falls below a predetermined threshold amount.

Alternatively, the aerosol-forming marker may be located at a radially central portion of the aerosol-forming substrate.

Locating the aerosol-forming marker at a radially central portion of the aerosol-forming substrate may allow the aerosol-forming marker to aerosolise relatively quickly when a heating blade type heater is used heat the aerosol-forming substrate. This arrangement may be advantageous in an example in which the control electronics causes deactivation of the heater when the amount of aerosol-forming marker detected by the electrochemical sensor switch falls below a predetermined threshold amount.

Locating the aerosol-forming marker at a radially central portion of the aerosol-forming substrate may allow the aerosol-forming marker to aerosolise relatively slowly when a heater that externally heats the aerosol-forming substrate is used. This arrangement may be advantageous in an example in which the control electronics causes deactivation of the heater when the amount of aerosol-forming marker detected by the electrochemical sensor switch exceeds a predetermined threshold amount

The aerosol-forming marker may comprise any substance that can aerosolise such that the substance can be detected by an electrochemical sensor switch when the substance is in its aerosolised form. The aerosol-forming marker may comprise any substance that can aerosolise and is not typically found in an aerosol-forming substrate. In one example, the aerosol-forming marker may be an isomeric compound. In one example, the aerosol-forming marker may comprise an isomer of xylene. In one example, the aerosol-forming marker may comprise an amine containing compound.

The aerosol-forming marker may be a gel. In another example, the aerosol-forming marker may be a solid.

The reservoir storing the aerosol-forming marker may be located within the aerosol-forming substrate.

The aerosol-generating device may comprise any suitable type of heater. For example, the heater may comprise an electric heater. In one example, the heater may comprise an electric heater comprising one or more heating elements. The one or more heating elements may be resistive heating elements.

In an example, the heater may comprise a heating blade for internally heating the aerosol-generating article. The heater may comprise a heating blade for internally heating the aerosol-generating article when the aerosol-generating article is inserted into the aerosol-generating device. In this example, when the aerosol-generating article is inserted into the aerosol-generating device, the heater blade can penetrate the aerosol-forming substrate. This may allow the aerosol-forming substrate to be heated directly without any heating of an external wrapper of the aerosol-generating article. The heating blade may be an internal heating blade. The heater may heat the aerosol-forming substrate from its inside.

In another example, the heater may comprise a heater arrangement configured to externally heat the aerosol-generating article. The heater may comprise a heater arrangement configured to externally heat the aerosol-generating article when the aerosol-generating article is inserted in to the aerosol-generating device. In this example, when the aerosol-generating article is inserted into the aerosol-generating device, the heater arrangement can heat the aerosol-forming substrate by directly heating an outer surface of the aerosol-generating article. The heater may partially or completely surround the aerosol-forming substrate and heat the aerosol-forming substrate circumferentially from its outside.

In another example, the heater may comprise an inductive heating device. Inductive heating devices typically comprise an induction source that is configured to be coupled to a susceptor, which may be provided externally to the aerosol-forming substrate or internally within the aerosol-forming substrate. The induction source generates an alternating electromagnetic field that induces magnetization or eddy currents in the susceptor. The susceptor may be heated as a result of hysteresis losses or induced eddy currents which heat the susceptor through ohmic or resistive heating.

The aerosol-generating device may include a susceptor. The susceptor may be as described above in relation to the aerosol-generating article.

An aerosol-generating device comprising an inductive heating device may be configured to receive an aerosol-generating article having the aerosol-forming substrate and a susceptor in thermal proximity to the aerosol-forming substrate. Typically, the susceptor is in direct contact with the aerosol-forming substrate and heat is transferred from the susceptor to the aerosol-forming substrate primarily by conduction.

Examples of electrically operated aerosol-generating systems having inductive heating devices and aerosol-generating articles having susceptors are described in WO-A1-95/27411 and WO-A1-2015/177255.

The aerosol-generating device may comprise a body into which the aerosol-generating article may be inserted. The aerosol-generating device may comprise a housing into which the aerosol-generating article may be inserted.

In one example, the aerosol-generating device may comprise an electrochemical sensor switch. The aerosol-generating device may comprise one or more electrochemical sensor switches. The aerosol-generating device may comprise a plurality of electrochemical sensor switches.

The aerosol-generating device may include a battery.

The aerosol-generating device may include a body. The aerosol-generating device may include a holding fixture for holding the aerosol-generating article in place when the aerosol-generating article is inserted into the body.

In one example, each electrochemical sensor switch is configured to determine an indication of when an aerosol-forming marker in the aerosol-generating article has been aerosolised. When an electrochemical sensor switch detects that the amount or concentration of an aerosol-forming marker is above a predetermined threshold, the electrochemical sensor switch changes from a first state to a second state. In response to the electrochemical sensor switch changing from a first state to a second state, the control electronics causes heater to deactivate.

In another example, each electrochemical sensor switch is configured to determine an indication of when an aerosol-forming marker in the aerosol-generating stops being aerosolised. When an electrochemical sensor switch detects that the amount or concentration of an aerosol-forming marker is below a predetermined threshold, the electrochemical sensor switch changes from a first state to a second state. In response to the electrochemical sensor switch changing from a first state to a second state, the control electronics causes heater to deactivate.

Each electrochemical sensor switch may have a sensitivity of between 10 parts per million by volume and 100 parts per million by volume. Preferably, each electrochemical sensor switch may have a sensitivity of between 20 parts per million by volume and 70 parts per million by volume.

Each electrochemical sensor switch may have a different conductivity in the first state than in the second state.

Any suitable electrochemical sensor switch for detecting an aerosol-forming marker compound may be used.

Each electrochemical sensor switch may comprise a chemiresistive material. In one example, each electrochemical sensor switch may include a coating of a chemiresistive material. In one example, each electrochemical sensor switch may include a layer of a chemiresistive material.

Each electrochemical sensor switch may comprise a semiconductive material. In one example, each electrochemical sensor switch may include a coating of a semiconductive material. In one example, each electrochemical sensor switch may include a layer of a semiconductive material.

Each electrochemical sensor switch may comprise one or more carbon nanotubes. In one example, each electrochemical sensor switch may comprise a composite of one or more carbon nanotubes and a metalloprphyrin that is chemically sensitive to the aerosol-forming marker.

Each electrochemical sensor switch may comprise coating carbon nanotubes or single-walled carbon nanotubes with gold-hafnium. Including coating carbon nanotubes or single-walled carbon nanotubes with gold-hafnium may amplify the detection capabilities.

The control electronics may be configured to control operation of the heater or other electrical components. The control electronics may be provided in any suitable form and may, for example, include a controller or a memory and a controller. The controller may include one or more of an Application Specific Integrated Circuit (ASIC) state machine, a digital signal processor, a gate array, a microprocessor, or equivalent discrete or integrated logic circuitry. The control electronics may include memory that contains instructions that cause one or more components of the control electronics to carry out a function or aspect of the control electronics. Functions attributable to control electronics in this disclosure may be embodied as one or more of software, firmware, and hardware.

The control electronics may be configured to control operation of the heater.

The control electronics may receive and process signals from the electrochemical sensor switch.

The control electronics may be configured to cause the heater to deactivate by stopping the supply of electricity to the heater.

The control electronics may be configured to cause output of an alert when the heater becomes deactivated. For example, the control electronics may cause illumination of a light such as an LED. In another example, the control electronics may cause a sound to be output through a speaker.

The control electronics may be configured to reactivate the heater when a new aerosol-generating article inserted into the aerosol-generating device.

The method of operating an aerosol-generating system may include any feature described above with respect to the aerosol-generating system.

It will be appreciated that any features described herein in relation to one embodiment of an aerosol-forming substrate, an aerosol-generating article, an aerosol-generating device, or an aerosol-generating system may also be applicable to other embodiments of aerosol-forming substrates, an aerosol-generating articles, an aerosol-generating devices, or aerosol-generating systems according to this disclosure. A feature described in relation to one embodiment may be equally applicable to another embodiment in accordance with this disclosure. It will also be appreciated that an aerosol generator according to this disclosure may be provided in an aerosol-generating device without a cartridge. Accordingly, any of the features described herein with relation to a cartridge may be equally applicable to an aerosol-generating device.

The invention is defined in the claims. However, below there is provided a non-exhaustive list of non-limiting examples. Any one or more of the features of these examples may be combined with any one or more features of another example, embodiment, or aspect described herein.

EX1. An aerosol-generating system comprising:
an aerosol-generating article comprising an aerosol-forming substrate and an aerosol-forming marker; and
an aerosol-generating device configured to receive the aerosol-generating article, the aerosol-generating device comprising:
control electronics;
an electrochemical sensor switch operably coupled to the control electronics, the electrochemical sensor switch being configured to change from a first state to a second state when the electrochemical sensor switch detects an amount of the aerosol-forming marker that is above or below a predetermined threshold amount; and
a heater operably coupled to the control electronics via the electrochemical sensor switch,
the control electronics being configured to cause the heater to deactivate when the electrochemical sensor switch changes from the first state to the second state.

EX2. An aerosol-generating system according to example EX1, wherein the aerosol-generating article comprises a reservoir containing the aerosol-forming marker.

EX3. An aerosol-generating system according to example EX1 or example EX2, wherein the aerosol-generating article comprises a plurality of reservoirs, each of the plurality of reservoirs containing the aerosol-forming marker.

EX4. An aerosol-generating system according to example EX2 or example EX3, wherein each reservoir comprises a capsule.

EX5. An aerosol-generating system according to example EX4, wherein each capsule comprises an outer shell.

EX6. An aerosol-generating system according to example EX5, wherein the outer shell is formed from a thermally degradable material.

EX7. An aerosol-generating system according to example EX5 or example EX6, wherein the outer shell is formed from a wax.

EX8. An aerosol-generating system according to any one of examples EX1 to EX7, wherein the aerosol-forming marker is positioned at one location within the aerosol-generating article.

EX9. An aerosol-generating system according to any one of examples EX1 to EX7, wherein the aerosol-forming marker is positioned at multiple locations within the aerosol-generating article.

EX10. An aerosol-generating system according to any one of examples EX1 to EX9, wherein the aerosol-forming marker is located at a radially outer portion of the aerosol-forming substrate.

EX11. An aerosol-generating system according to any one of examples EX1 to EX10, wherein the aerosol-forming marker is located at a radially central portion of the aerosol-forming substrate.

EX12. An aerosol-generating system according to any one of examples EX1 to EX11, wherein the aerosol-forming marker comprises an isomer of xylene.

EX13. An aerosol-generating system according to any one of examples EX1 to EX12, wherein the aerosol-forming marker comprises an amine containing compound.

EX14. An aerosol-generating system according to any one of examples EX1 to EX13, wherein the aerosol-forming marker is a gel.

EX15. An aerosol-generating system according to any one of examples EX1 to EX14, wherein the heater comprises a heating blade for internally heating the aerosol-generating article.

EX16. An aerosol-generating system according to any one of examples EX1 to EX15, wherein the heater comprises a heater arrangement configured to externally heat the aerosol-generating article.

EX17. An aerosol-generating system according to any one of examples EX1 to EX 16, wherein the aerosol-generating device comprises a body into which the aerosol-generating article may be inserted.

EX18. An aerosol-generating system according to any one of examples EX1 to EX17, wherein the aerosol-generating device comprises a plurality of electrochemical sensor switches.

EX19. An aerosol-generating system according to any one of examples EX1 to EX18, wherein each electrochemical sensor switch has a different conductivity in the first state than in the second state.

EX20. An aerosol-generating system according to any one of examples EX1 to EX19, wherein each electrochemical sensor switch comprises a chemiresistive material.

EX21. An aerosol-generating system according to any one of examples EX1 to EX19, wherein each electrochemical sensor switch comprises a semiconductive material.

EX22. An aerosol-generating system according to examples EX20 or example EX21, wherein each electrochemical sensor switch comprises one or more carbon nanotubes.

EX23. An aerosol-generating system according to any one of examples EX1 to EX22, wherein the control electronics is configured to cause the heater to deactivate by causing the supply of electricity to the heater to stop.

EX24. An aerosol-generating system according to any one of examples EX1 to EX23, wherein the control electronics is configured to cause output of an alert when it causes the heater to deactivate.

EX25. A method of operating an aerosol-generating system comprising an aerosol-generating article and an aerosol-generating article, the method comprising:
control electronics causing deactivation of a heater of the aerosol-generating device in response to an electrochemical sensor switch detecting that an amount of an aerosol-forming marker is above or below a predetermined threshold amount.

EX26. A method of operating an aerosol-generating system according to example EX25, comprising the control electronics causing deactivation of the heater by causing the supply of electricity to the heater to be stopped.

EX27. A method of operating an aerosol-generating system according to example EX25 or example EX26, comprising the control electronics causing output of an alert when it causes the heater to deactivate.

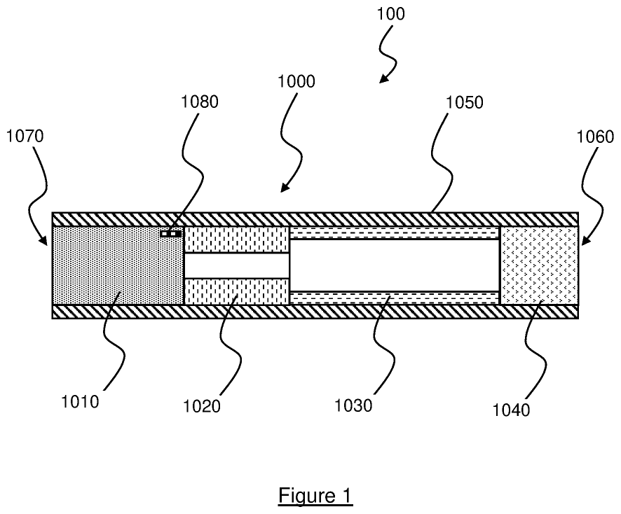

FIG. 1 illustrates schematically a first example of an aerosol-generating article according to the aerosol-generating system as described herein;

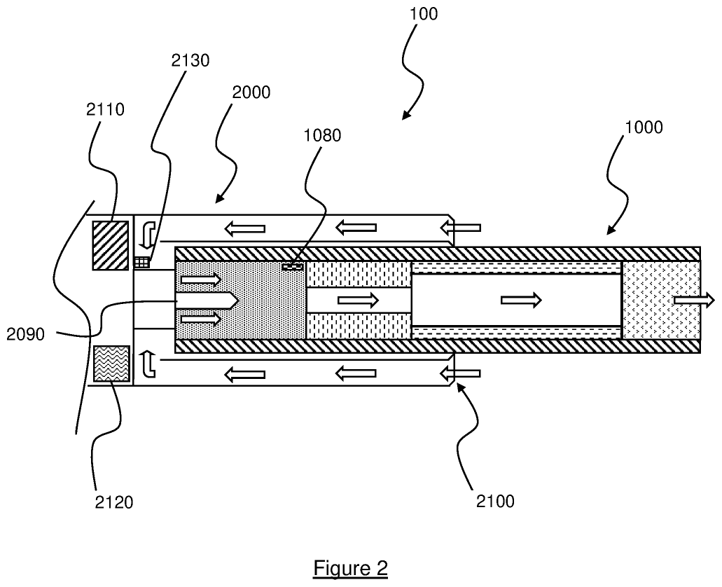

FIG. 2 illustrates schematically the aerosol-generating article of FIG. 1 when inserted into a first example of an aerosol-generating device according to the aerosol-generating system as described herein;

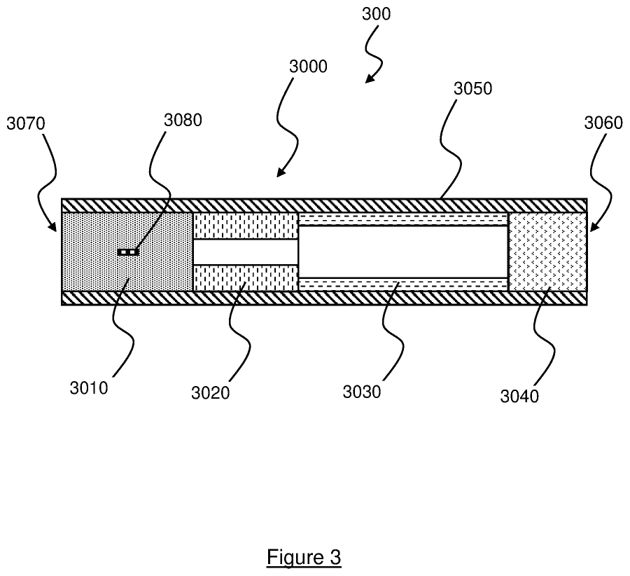

FIG. 3 illustrates schematically a second example of an aerosol-generating article according to the aerosol-generating system as described herein;

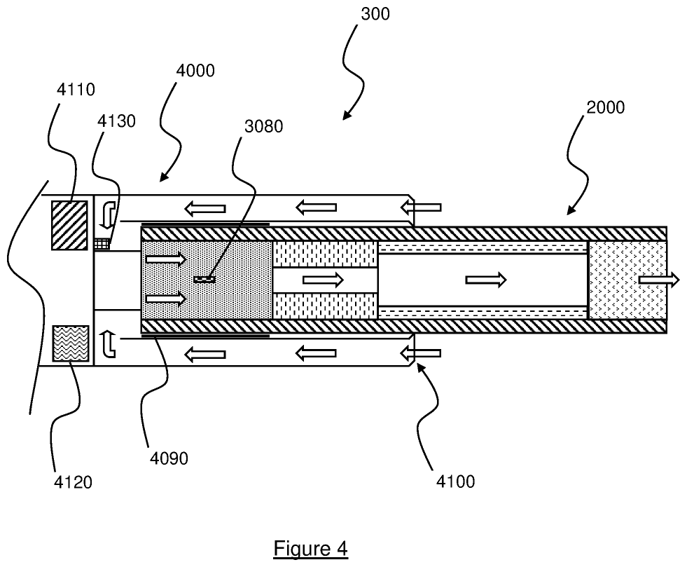

FIG. 4 illustrates schematically the aerosol-generating article of FIG. 3 when inserted into a second example of an aerosol-generating device according to the aerosol-generating system as described herein;

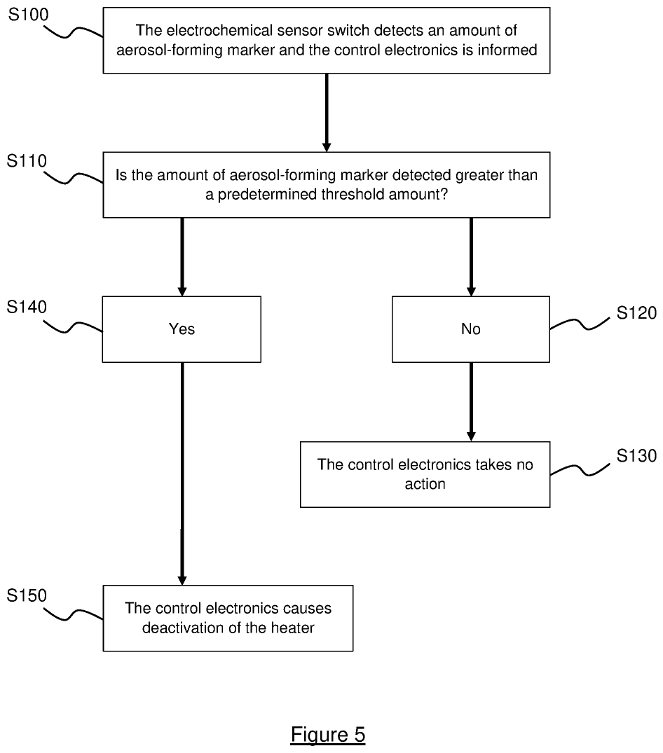

FIG. 5 illustrates schematically a first example of a method of operating the aerosol-generating system shown in FIGS. 1 and 2; and

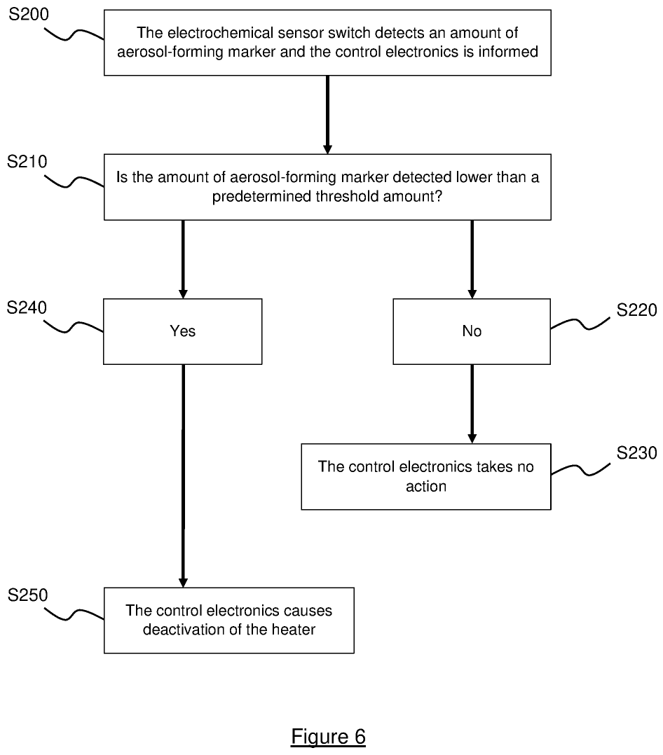

FIG. 6 illustrates schematically a second example of a method of operating the aerosol-generating system shown in FIGS. 1 and 2.

Aerosol-generating systems for delivering an aerosol to a user typically comprise an atomiser configured to generate an inhalable aerosol from an aerosol-forming substrate. Some known aerosol-generating systems comprise a thermal atomiser such as an electric heater or an inductive heating device. The thermal atomiser is configured to heat and vaporise the aerosol-forming substrate to generate an aerosol. Typical aerosol-forming substrates for use in aerosol-generating systems are nicotine formulations, which may be liquid nicotine formulations comprising an aerosol former such as glycerine and/or propylene glycol.

An aerosol-generating article typically includes a fixed amount of an aerosol-forming substrate. However, the aerosol-forming substrate in an aerosol-generating article may be consumed at different rates by different users. This means that the point at which an aerosol-generating article will stop delivering an expected experience to the user may vary between different users.

Conventional aerosol-generating systems are not able to detect the point at which an aerosol-generating article will stop delivering an expected experience to the user. This means that conventional aerosol-generating systems determine that an aerosol-generating article is depleted of its aerosol-forming substrate based on ‘standard’ settings such as number of puffs or time duration. Consequently, the variation in consumption of an aerosol-forming substrate in an aerosol-generating article by different users may cause a number of problems.

Firstly, a user trying to consume aerosol from an aerosol-generating article that is depleted or nearly depleted of aerosol-forming substrate will be given an unsatisfactory and inconsistent user experience.

Secondly, an aerosol-generating device heating an aerosol-generating article that has been depleted or nearly depleted of aerosol-forming substrate wastes energy, which reduces the battery life of the aerosol-generating device.

It would be desirable to provide an aerosol-generating system that can determine an indication of when an aerosol-generating article may be depleted of its aerosol-forming substrate, or is nearing depletion of its aerosol-forming substrate.

The invention described in this application seeks to address this problem.

FIGS. 1 and 2 illustrate a first example of an aerosol-generating system 100 according to the invention. The aerosol-generating system 100 includes an aerosol-generating article 1000 and an aerosol-generating device 2000. FIG. 1 shows a first example of an aerosol-generating article 1000. FIG. 2 shows a first example of an aerosol-generating article 1000 when inserted into a first example of an aerosol-generating device 2000.

In the example of FIG. 1, the aerosol-generating article 1000 includes four elements: the aerosol-forming substrate 1010, a hollow cellulose acetate tube 1020, a spacer element 1030, and a mouthpiece filter 1040. The four elements 1010, 1020, 1030, 1040 are arranged sequentially and in a coaxial alignment. The four elements 1010, 1020, 1030, 1040 are assembled by a cigarette paper 1050 to form the aerosol-generating article 1000.

In the example of FIG. 1, the aerosol-generating article 1000 has a mouth-end 1060 and a distal end 1070. A user may insert the mouth-end 1060 into his or her mouth during use. The distal end 1070 is located at the opposite end of the aerosol-generating article 1000 to the mouth end 1060. The example of an aerosol-generating article 1000 illustrated in FIG. 1 is particularly suitable for use with an electrically-operated aerosol-generating device comprising a heater for heating the aerosol-forming substrate 1010.

In one example, when assembled, the aerosol-generating article 1000 is about 45 millimetres in length and has an outer diameter of about 7.2 millimetres and an inner diameter of about 6.9 millimetres.

In the example of FIG. 1, the aerosol-forming substrate 1010 is provided in the form of a plug made by crimping a sheet of aerosol-forming substrate. The sheet is gathered, crimped and wrapped in a filter paper (not shown) to form the plug. The aerosol-forming substrate may be tobacco. The tobacco may be in any form. For example, the tobacco may be cut or shredded pieces of leaf or stem. The tobacco may be reconstituted. The tobacco may be extruded. The tobacco may be powdered. The tobacco may be granulated. The tobacco may be compressed. The tobacco may be formed. The tobacco may be pelletized. The tobacco may be in the form of a tobacco extract. The tobacco may be treated, reconstituted or otherwise prepared. The aerosol-forming substrate may include flavour elements. The flavour elements may include, for example, menthol, cocoa, vanilla or licorice. The aerosol-forming substrate may include aerosolization-enhancing agents such as glycerine or propylene glycol.

The example of the aerosol-generating article 1000 illustrated in FIG. 1 is designed to engage with an aerosol-generating device in order to be consumed. Such an aerosol-generating device includes means for heating the aerosol-forming substrate 1010 to a sufficient temperature to form an aerosol. Typically, the aerosol-generating device may comprise a heating element that surrounds the aerosol-generating article 1000 adjacent to the aerosol-forming substrate 1010, or a heating element that is inserted into the aerosol-forming substrate 1010.

Once engaged with an aerosol-generating device, a user draws on the mouth-end 1060 of the aerosol-generating article 1000 and the aerosol-forming substrate 1010 is heated to a temperature of about 375 degrees Celsius. At this temperature, volatile compounds are evolved from the aerosol-forming substrate 1010. These compounds condense to form an aerosol. The aerosol is drawn through the filter 1040 and into the user's mouth. The heater may be a resistive heater.

The aerosol-generating article 1000 includes an aerosol-forming marker 1080. The aerosol-forming marker 1080 may be an isomeric compound. In this example, the aerosol-forming marker 1080 is an isomer of xylene. In the example shown in FIG. 1, the aerosol-generating article 1000 has a reservoir and the aerosol-forming marker 1080 is stored in the reservoir. In the example shown in FIG. 1, the reservoir is capsule. The capsule has an outer shell. The outer shell may be formed from any suitable material that can break down to release the aerosol-forming marker 1080. For example, the outer shell of the capsule may be formed from a material that is thermally degradable, such as a wax.

In the example of FIG. 1, when the outer shell is heated to a particular temperature, the outer shell begins to thermally degrade, which releases the aerosol-forming marker 1080 from the reservoir.

The reservoir storing the aerosol-forming marker 1080 may be located at any position within the aerosol-generating article 1000. In the example of FIG. 1, the reservoir storing the aerosol-forming marker 1080 is contained within the aerosol-forming substrate 1010.

The reservoir storing the aerosol-forming marker 1080 may be located at a position within the aerosol-forming substrate 1010 that can allow the aerosol-forming marker 1080 to be aerosolised only once at least most of the aerosol-forming substrate 1010 has been aerosolised. In the example shown in FIG. 1, the reservoir storing the aerosol-forming marker 1080 is located at a radially outer portion of the aerosol-generating article 1000. This is because, as is discussed below, the first example of the aerosol-generating article 1000 is designed to be inserted into an aerosol-generating device 2000 that includes a heating blade.

In the example of FIG. 2, the aerosol-generating article 1000 shown in FIG. 1 is inserted into the aerosol-generating device 2000.

FIG. 2 illustrates only a portion of the aerosol-generating device 2000. The aerosol-generating device includes a heater for heating the aerosol-generating substrate 1010 of the aerosol-generating article 1000. In the example of FIG. 2 the heater 2090 is a heating blade. In the example of FIG. 2, the heater 2090 is mounted within a receiving chamber. The aerosol-generating device 2000 defines a plurality of air holes 2100 for allowing air to flow into the aerosol-generating article 1000. Air flow is indicated by the arrows in FIG. 2. The aerosol-generating article 1000 of FIG. 2 is the same as described in relation to FIG. 1.

Due to the geometry of the aerosol-generating article 1000 and the location of the heater 2090, when aerosol-generating article 1000 is heated by the aerosol-generating device 2000, the aerosol-generating article 1000 experiences, a temperature gradient across its diameter. The radially inner or central portion of the aerosol-generating article 1000 exhibits a higher temperature than the radially outer portion of the aerosol-generating article 1000. Therefore, the region of the aerosol-forming substrate 1010 that is radially central is the first region of the aerosol-forming substrate 1010 to aerosolise. Eventually, the radially outer region of the aerosol-forming substrate 1010 is heated to a sufficient temperature that it also begins to aerosolise. At this point, the aerosol-forming marker 1080, which in this example is located in a radially outer region of the aerosol-forming substrate 1010, also aerosolises.

The aerosol-generating device 2000 has a power supply. In the example of FIG. 2, the power supply is a battery 2110.

The aerosol-generating device 2000 includes control electronics 2120 for controlling operation of the aerosol-generating device 2000. The control electronics 2120 may include a processor or the like.

The aerosol-generating device 2000 has an electrochemical sensor switch 2130. In another example, the aerosol-generating device 2000 may have a plurality of electrochemical sensor switches. In the example of FIG. 2, the electrochemical sensor switch 2130 is operably coupled to the control electronics 2120. The electrochemical sensor switch 2130 is configured to change from a first state to a second state when the electrochemical sensor switch 2130 detects an amount of the aerosol-forming marker 1080 that is above or below a predetermined threshold amount. In the example of FIG. 2, the electrochemical sensor switch 2130 has a different conductivity in the first state than in the second state.

The control electronics 2120 is configured to cause the heater 2090 to deactivate in response to the electrochemical sensor switch 2130 changing from the first state to the second state.

In other words, the control electronics 2120 deactivates the heater 2090 when the electrochemical sensor switch 2130 detects an amount of the aerosol-forming marker 1080 that is above or below a predetermined threshold amount.

In some examples, the control electronics 2120 deactivates the heater 2090 when the electrochemical sensor switch 2130 detects an amount of the aerosolised aerosol-forming marker 1080 that is above a predetermined threshold amount. In some examples, the control electronics 2120 deactivates the heater 2090 when the electrochemical sensor switch 2130 detects an amount of the aerosol-forming marker 1080 that is below a predetermined threshold amount.

FIGS. 3 and 4 illustrate a second example of an aerosol-generating system 300 according to the invention. The aerosol-generating system 300 includes an aerosol-generating article 3000 and an aerosol-generating device 4000. FIG. 3 shows a second example of an aerosol-generating article 3000. FIG. 4 shows a second example of an aerosol-generating article 3000 when inserted into a first example of an aerosol-generating device 4000.

The aerosol-generating article 3000 shown in FIG. 3 is similar to the aerosol-generating article 1000 shown in FIG. 1 except for the location of the aerosol-forming marker 3080. In the first example shown in FIG. 1, the reservoir storing the aerosol-forming marker 1080 is located at a radially outer portion of the aerosol-generating article 1000. In contrast, in the second example shown in FIG. 3, the reservoir storing the aerosol-forming marker 3080 is located at a radially central portion of the aerosol-generating article 3000.

In the example of FIG. 3, the aerosol-generating article 3000 includes four elements: the aerosol-forming substrate 3010, a hollow cellulose acetate tube 3020, a spacer element 3030, and a mouthpiece filter 3040. The four elements 3010, 3020, 3030, 3040 are arranged sequentially and in a coaxial alignment. The four elements 3010, 3020, 3030, 3040 are assembled by a cigarette paper 3050 to form the aerosol-generating article 3000.

In the example of FIG. 3, the aerosol-generating article 3000 has a mouth-end 3060 and a distal end 3070. A user may insert the mouth-end 3060 into his or her mouth during use. The distal end 3070 is located at the opposite end of the aerosol-generating article 3000 to the mouth end 3060. The example of an aerosol-generating article 3000 illustrated in FIG. 3 is particularly suitable for use with an electrically-operated aerosol-generating device comprising a heater for heating the aerosol-forming substrate 3010.

In one example, when assembled, the aerosol-generating article 3000 is about 45 millimetres in length and has an outer diameter of about 7.2 millimetres and an inner diameter of about 6.9 millimetres.

In the example of FIG. 3, the aerosol-forming substrate 3010 is provided in the form of a plug made by crimping a sheet of aerosol-forming substrate. The sheet is gathered, crimped and wrapped in a filter paper (not shown) to form the plug.

The example of the aerosol-generating article 3000 illustrated in FIG. 3 is designed to engage with an aerosol-generating device in order to be consumed. Such an aerosol-generating device includes means for heating the aerosol-forming substrate 3010 to a sufficient temperature to form an aerosol. Typically, the aerosol-generating device may comprise a heating element that surrounds the aerosol-generating article 3000 adjacent to the aerosol-forming substrate 3010, or a heating element that is inserted into the aerosol-forming substrate 3010.

Once engaged with an aerosol-generating device, a user draws on the mouth-end 3060 of the aerosol-generating article 3000 and the aerosol-forming substrate 3010 is heated to a temperature of about 375 degrees Celsius. At this temperature, volatile compounds are evolved from the aerosol-forming substrate 3010. These compounds condense to form an aerosol. The aerosol is drawn through the filter 3040 and into the user's mouth.

The aerosol-generating article 3000 includes an aerosol-forming marker 3080. The aerosol-forming marker 3080 may be an isomeric compound. In this example, the aerosol-forming marker 3080 is an isomer of xylene. In the example shown in FIG. 1, the aerosol-generating article 3000 has a reservoir and the aerosol-forming marker 3080 is stored in the reservoir. In the example shown in FIG. 3, the reservoir is capsule. The capsule has an outer shell. The outer shell may be formed from any suitable material that can break down to release the aerosol-forming marker 3080. For example, the outer shell of the capsule may be formed from a material that is thermally degradable, such as a wax.

In the example of FIG. 3, when the outer shell is heated to a particular temperature, the outer shell begins to thermally degrade, which releases the aerosol-forming marker 3080 from the reservoir.

The reservoir storing the aerosol-forming marker 3080 may be located at any position within the aerosol-generating article 3000. In the example of FIG. 3, the reservoir storing the aerosol-forming marker 3080 is contained within the aerosol-forming substrate 3010.

The reservoir storing the aerosol-forming marker 3080 may be located at a position within the aerosol-forming substrate 3010 that can allow the aerosol-forming marker 3080 to be aerosolised only once at least most of the aerosol-forming substrate 3010 has been aerosolised. In the example shown in FIG. 3, the reservoir storing the aerosol-forming marker 3080 is located at a radially central portion of the aerosol-generating article 3000. This is because, as is discussed below, the second example of the aerosol-generating article 3000 is designed to be inserted into an aerosol-generating device 4000 that includes an external heater that partially surround the outer surface of the aerosol-generating article 1000. In this arrangement, the heater heats the aerosol-forming substrate 3010 from its outside.

In the example of FIG. 4, the aerosol-generating article 3000 shown in FIG. 4 is inserted into the aerosol-generating device 4000.

FIG. 4 illustrates only a portion of the aerosol-generating device 4000. The aerosol-generating device includes a heater 4090 for heating the aerosol-generating substrate 4010 of the aerosol-generating article 4000. In the example of FIG. 4, the heater 4090 is an arrangement that partially surrounds the outside surface of the aerosol-generating article 3000. The aerosol-generating device 4000 defines one or more air holes 4100 for allowing air to flow into the aerosol-generating article 3000. Air flow is indicated by the arrows in FIG. 4. The aerosol-generating article 3000 of FIG. 4 is the same as described in relation to FIG. 3.

Due to the geometry of the aerosol-generating article 1000 and the location of the heater 2090, when aerosol-generating article 1000 is heated by the aerosol-generating device 2000, the aerosol-generating article 1000 experiences, a temperature gradient across its diameter. The radially outer portion of the aerosol-generating article 1000 exhibits a higher temperature than the radially inner portion of the aerosol-generating article 1000. Therefore, the region of the aerosol-forming substrate 1010 that is radially outer is the first region of the aerosol-forming substrate 1010 to aerosolise. Eventually, the radially inner region of the aerosol-forming substrate 1010 is heated to a sufficient temperature that it also begins to aerosolise. At this point, the aerosol-forming marker 1080, which in this example is located in a radially inner region of the aerosol-forming substrate 1010, also aerosolises.

The aerosol-generating device 4000 has a power supply. In the example of FIG. 4, the power supply is a battery 4110.

The aerosol-generating device 4000 includes control electronics 4120 for controlling operation of the aerosol-generating device 4000. The control electronics 4120 may include a processor or the like.

The aerosol-generating device 4000 has an electrochemical sensor switch 4130. In another example, the aerosol-generating device 4000 may have a plurality of electrochemical sensor switches. In the example of FIG. 4, the electrochemical sensor switch 4130 is operably coupled to the control electronics 4120. The electrochemical sensor switch 4130 is configured to change from a first state to a second state when the electrochemical sensor switch 4130 detects an amount of the aerosolised aerosol-forming marker 3080 that is above or below a predetermined threshold amount. In the example of FIG. 4 the electrochemical sensor switch 4130 has a different conductivity in the first state than in the second state.

The control electronics 4120 is configured to cause the heater 4090 to deactivate in response to the electrochemical sensor switch 4130 changing from the first state to the second state.

In other words, the control electronics 4120 deactivates the heating blade 4090 when the electrochemical sensor switch 4130 detects an amount of the aerosol-forming marker 3080 that is above or below a predetermined threshold amount.

In some examples, the control electronics 4120 deactivates the heating blade 4090 when the electrochemical sensor switch 4130 detects an amount of the aerosol-forming marker 3080 that is above a predetermined threshold amount. In some examples, the control electronics 4120 deactivates the heating blade 4090 when the electrochemical sensor switch 4130 detects an amount of the aerosol-forming marker 3080 that is below a predetermined threshold amount.

Two examples of methods of operating the aerosol-generating system shown in FIGS. 1 and 2 will now be described, with reference to FIGS. 5 and 6.

In the first example, shown in FIG. 5, the control electronics 2120 causes the heater to 2090 to deactivate when the electrochemical sensor switch 2130 detects an amount of aerosolised aerosol-forming marker 1080 that is above a predetermined threshold amount.

At S100, a user is using the aerosol-generating article 1000. The aerosol-generating article 1000 has been inserted into the aerosol-generating device 2000 and the heater 2090 is heating the aerosol-forming substrate 1010, which begins to aerosolise. Heating the aerosol-forming substrate 1010 also heats the capsule containing the aerosol-forming marker 1080. The user draws the generated aerosol through the mouthpiece filter 1040.

Once the capsule containing the aerosol-forming marker 1080 has been heated sufficiently, the capsule melts, which releases the aerosol-forming marker 1080 into the aerosol-forming substrate 1010. Release of the aerosol-forming marker 1080 from the capsule allows the aerosol-forming marker 1080 to be aerosolised by the heater 2090.

Since the electrochemical sensor switch 2130 is in close proximity to the aerosol-forming substrate 1010, the electrochemical sensor switch 2130 is in relatively close proximity to the aerosol-forming marker 1080 now being aerosolised. The control electronics 2110 is informed when the electrochemical sensor switch 2130 detects the presence of the aerosol-forming marker 1080.

At S110, the control electronics 2110 compares the amount of aerosolised aerosol-forming marker 1080 detected to a predetermined threshold amount. For example, the control electronics 2110 may compare the concentration of detected aerosol-forming marker 1080 to a predetermined threshold concentration.

At S120, if the amount of aerosolised aerosol-forming marker 1080 is not greater than the predetermined threshold amount the method proceeds to S130.

At S130, the control electronics 2110 takes no further action in respect of the detected amount of aerosolised aerosol-forming marker 1080.

At S140, if the amount of aerosolised aerosol-forming marker 1080 is greater than the predetermined threshold amount then the method proceeds to S140.

At S150, the control electronics 2110 causes the heater to deactivate. For example, the heater may cause the supply of electricity from the battery 2110 to the heater 2090 to stop.

In the first example, the aerosol-forming marker 1080 is aerosolised from the start of the user experience. When the aerosol-forming marker 1080 becomes depleted such that the concentration of aerosolised aerosol-forming marker 1080 detected by the electrochemical sensor switch 2130 falls below a certain predetermined threshold, the control electronics 2120 switches off the heater 2090.

In the second example, shown in FIG. 6, the control electronics 2120 causes the heater to 2090 to deactivate when the electrochemical sensor switch 2130 detects an amount of aerosolised aerosol-forming marker 1080 that is below a predetermined threshold amount.

At S200, a user is using the aerosol-generating article 1000. The aerosol-generating article 1000 has been inserted into the aerosol-generating device 2000 and the heater 2090 is heating the aerosol-forming substrate 1010, which begins to aerosolise. Heating the aerosol-forming substrate 1010 also heats the capsule containing the aerosol-forming marker 1080. The user draws the generated aerosol through the mouthpiece filter 1040.

Once the capsule containing the aerosol-forming marker 1080 has been heated sufficiently, the capsule melts, which releases the aerosol-forming marker 1080 into the aerosol-forming substrate. Release of the aerosol-forming marker 1080 from the capsule allows the aerosol-forming marker 1080 to be aerosolised by the heater 2090.

Since the electrochemical sensor switch 2130 is in close proximity to the aerosol-forming substrate 1010, the electrochemical sensor switch 2130 is in relatively close proximity to the aerosol-forming marker 1090 now being aerosolised. The control electronics 2120 is informed when the electrochemical sensor switch 2130 detects the presence of the aerosol-forming marker 1080.

At S210, the control electronics 2120 compares the amount of aerosolised aerosol-forming marker 1080 detected to a predetermined threshold amount. For example, the control electronics 2120 may compare the concentration of detected aerosol-forming marker 1080 to a predetermined threshold concentration.

At S220, if the amount of aerosolised aerosol-forming marker 1080 is not less than the predetermined threshold amount the method proceeds to S230.

At S230, the control electronics 2120 takes no further action in respect of the detected amount of aerosolised aerosol-forming marker 1080.

At S240, if the amount of aerosolised aerosol-forming marker 1080 is less than the predetermined threshold amount then the method proceeds to S240.

At S250, the control electronics 2120 causes the heater 2090 to deactivate. For example, the heater may cause the supply of electricity from the battery 2110 to the heater 2090 to stop.

In the second example, the aerosol-forming marker 1080 is only aerosolised some time after start of the user experience. The exact timing of when the aerosol-forming marker 1080 begins to be aerosolised depends on how the aerosol-generating article 1000 is being used. For example, if the user is using the aerosol-generating article 1000 very quickly then the aerosol-forming marker 1080 will begin to aerosolise sooner than it would if the user is using the aerosol-generating article 1000 slowly. Aerosolization of the aerosol-forming marker 1080 may provide an indication of actual usage of the aerosol-generating article 1000 by a user. When the aerosol-forming marker 1080 is aerosolised to the extent that the concentration of aerosolised aerosol-forming marker 1080 detected by the electrochemical sensor switch 2130 increases above a certain predetermined threshold, the control electronics 2120 switches off the heater 2090.

The first example of a method described with respect to FIG. 5 may have the same advantages as the method described with respect to FIG. 6.

Advantageously, with the above arrangement, the aerosol-generating device 2000 may automatically stop heating the aerosol-generating article 1000 when the aerosol-forming substrate 1010 is depleted. This may lead to more effective energy management of the battery 2110 because the battery 2110 can stop supplying power to the heater 2090 when there is no more aerosol-forming substrate 1010 left to aerosolise.

Advantageously, with the above arrangement, a more consistent and satisfactory user experience may be provided to a user, because the user is not allowed to try to generate an aerosol-generating article 1000 with a depleted aerosol-forming substrate 1010.

The examples described above are not intended to limit the scope of the claims. Other examples consistent with the exemplary examples described above will be apparent to those skilled in the art. Features described in relation to one example may also be applicable to other examples.

1.-15. (canceled)

16. An aerosol-generating system, comprising:
an aerosol-generating article comprising an aerosol-forming substrate and an aerosol-forming marker; and
an aerosol-generating device configured to receive the aerosol-generating article,
wherein the aerosol-generating device comprises:
control electronics,
an electrochemical sensor switch operably coupled to the control electronics, the electrochemical sensor switch being configured to change from a first state to a second state when the electrochemical sensor switch detects an amount of the aerosol-forming marker that is above or below a predetermined threshold amount, and
a heater operably coupled to the control electronics via the electrochemical sensor switch,
the control electronics being configured to cause the heater to deactivate when the electrochemical sensor switch changes from the first state to the second state, and
wherein the aerosol-generating article comprises a reservoir containing the aerosol-forming marker, the reservoir comprising a capsule comprising an outer shell formed from a thermally degradable material.

17. The aerosol-generating system according to claim 16, wherein the aerosol-generating article comprises a plurality of reservoirs, each of the plurality of reservoirs containing the aerosol-forming marker.

18. The aerosol-generating system according to claim 17, wherein each reservoir of the plurality of reservoirs comprises a capsule.

19. The aerosol-generating system according to claim 18, wherein each capsule comprises an outer shell.

20. The aerosol-generating system according to claim 19, wherein the outer shell is formed from a thermally degradable material.

21. The aerosol-generating system according to claim 19, wherein the outer shell is formed from a wax.

22. The aerosol-generating system according to claim 16, wherein the aerosol-forming marker is located at a radially outer portion of the aerosol-forming substrate.

23. The aerosol-generating system according to claim 16, wherein the aerosol-forming marker is located at a radially central portion of the aerosol-forming substrate.

24. The aerosol-generating system according to claim 16, wherein the aerosol-forming marker comprises an isomer of xylene or an amine containing compound.

25. The aerosol-generating system according to claim 16, wherein the aerosol-forming marker is a gel.

26. The aerosol-generating system according to claim 16, wherein the electrochemical sensor switch has a different conductivity in the first state than in the second state.

27. The aerosol-generating system according to claim 16, wherein the electrochemical sensor switch comprises a chemiresistive material.

28. The aerosol-generating system according to claim 16, wherein the electrochemical sensor switch comprises a semiconductive material.

29. The aerosol-generating system according to claim 16, wherein the electrochemical sensor switch comprises one or more carbon nanotubes.
